(19) United States
(12) Patent Application Publication
(10) Pub. No.: US 2003/0122971 A1
(43) Pub. Date: Jul. 3, 2003

(54) Digital broadcast delivery method, digital broadcast delivery system, and accounting method using the same

(76) Inventor: Kenji Tanaka, Tokyo (JP)

Correspondence Address: BIRCH STEWART KOLASCH & BIRCH, PO BOX 747, FALLS CHURCH, VA, 22040-0747, US

(21) Appl. No.: 10/329,002

(22) Filed: Dec. 26, 2002

(30) Foreign Application Priority Data
Dec. 28, 2001 (JP) 2001-400003

(51) Int. Cl. H04N 9/74; H04N 5/38

(52) U.S. Cl. 348/723; 348/584

(57) ABSTRACT

It is an object of the present invention to provide a digital broadcast delivery method which copes with various broadcasting systems from one set of digital contents by effectively using the characteristics of digital contents. As a method of achieving the object, a super-high definition video image having a resolution higher than that of a conventional broadcasting system are input to a digital contents editing device according to the invention, and a video range (e.g., two portions) in the super-high definition video image is delivered to a receiving terminal. In the receiving terminal, different video images can be viewed and heard by a broadcasting system in conformity with a conventional broadcasting system.

### BACKGROUND OF THE INVENTION

Chances of production and delivery of digital contents are dramatically increased in number by a recent advance in communication technique such as the internet multi-channeling of television broadcasting by satellite broadcasting or the like in not only large-scale broadcasting companies but also medium and small contents delivery companies and individuals.

For example, in Japan, although the conventional NTSC system is used in television broadcasting, an increase in resolution of the HDTV system is advanced. Broadcasting companies must cope with receiving devices on the receiver side. In addition, reception of digital contents rapidly become popular for not only television sets but also desk-top- and notebook-type personal computers which can receive the digital contents through the internet or the like. With recent popularization of broadband, reception of the contents by the personal computers becomes popular.

Furthermore, a mobile terminal such as an information terminal called a PDA or a mobile phone has had an ability of digital contents to be received and reproduced with multi-functionalizing, and has attracted attention as a receiving device.

However, according to the conventional system, although many sources broadcasted for television are produced as digital contents, the digital contents must be separately produced for, e.g., broadcasting by the NTSC system and broadcasting by the HDTV system in advance. There is provided no delivery method which can cope with the plurality of receiving devices described above.

In particular, in the conventional configuration, contents delivery cannot be realized by one system for television broadcasting and contents delivery through the internet.

For this reason, in order to photograph video images which cope with a plurality of broadcasting systems, photographing devices such as cameras and staffs are required. Therefore, costs increase, and the quality of contents to be broadcasted is hardly improved.

In addition, since the category of a video image to be broadcasted determined by a contents delivery side, an audience passively watches only one video image determined by camera operators and editors. The audience cannot select a video image suitable for her/his taste.

As a conventional method for solving the above problems, an example in which a plurality of video camera images are broadcasted by different channels at once is known. However, the range of selection is merely widened, and perfectly free selection of an audience cannot be realized. Furthermore, in this method, many more photographing devices, staffs, and channels to be allocated are required.

The present invention relates to a digital broadcast delivery method and system for delivering digital contents such as video images and audio data. In particular, this invention can be applied to a plurality of broadcasting systems to make the delivery method versatile.

### SUMMARY OF THE INVENTION

The present invention has been created in consideration of the problems included in the above prior art, and has as its object to provide a digital broadcast delivery method which copes with various broadcasting systems from one set of digital contents by effectively using the characteristics of digital contents and, at the same time, to support the needs of various audiences.

In order to solve the above problem, according to the present invention, there is provided a digital contents delivery method described below.

More specifically, there is created a digital broadcast delivery method for transmitting digital contents from a transmission side to a reception side, wherein the digital contents are divided into predetermined blocks, and combinations of the blocks are freely changed to reproduce an arbitrary range of at least a part of the digital contents.

In this manner, in particular, the digital contents produced by using a photographing device having a very high resolution is used to make it possible to performed digital contents delivery coping with a plurality of broadcasting systems without deteriorating image quality, suppression of costs and improvement of contents quality can be achieved.

In the process of compressing the digital video contents related to a video image of the digital contents into digital contents the amount of which is smaller than that of original data of the video image, when a tiling process for dividing the video image into a plurality of video images and coding the video images is performed, the method according to the present invention is especially advantageously employed.

The digital contents have an amount of data increasing with improvement of image quality and cannot be easily delivered. Therefore, a compression technique which has been rapidly advanced in recent years is used, and standardization for performing the tiling process is used in the compression, and at least some of the tiles are combined to be reconstructed. When reconstruction is performed on the transmission side, a video image in a video range desired on an audience side can be delivered with a small amount of data. In addition, the digital contents subjected to the tiling process may be delivered, and a desired video image can be selected on the reception side.

According to this method, pieces of video information which are required for direction of program broadcasting are photographed at once, depending on some video images desired by an audience or restriction caused by conditions of a receiving device of the audience, a delivery method depending on needs can also be realized.

Furthermore, on the reception side of the digital broadcast delivery method, at least two ranges of digital contents in a first range constituted by at least a part of the range of the digital contents and digital contents in a second range constituted by a range different from the range of the digital contents in the first range may be simultaneously delivered, and a desired range may be selected to perform reproduction on the reception side.

In the invention, not only video data but also audio data of the digital contents are delivered in relation to the video data, real contents delivery with concert-hall presence can be realized.

For this reason, in a configuration in which digital video contents including digital audio contents related to sound are used to display at least a part of a display range of the digital video contents, the digital audio contents are converted into sound depending on the display range and reproduced.

Furthermore, according to the present invention, there is also provided the following digital broadcast delivery system for delivering digital contents from a delivery station to a digital broadcast receiving terminal.

In the digital broadcast delivery system, the delivery station includes a contents forming device, a contents dividing device, a contents editing device, and a delivery device, and the digital broadcast receiving terminal includes a receiving device and a display device.

In the contents dividing device, of digital contents including video information having a high resolution and formed by the contents forming device, digital video contents related to a video image is divided into video regions of a fixed size serving as blocks to form first digital contents.

On the other hand, the contents editing device includes contents input means for inputting the first digital contents into the device, output range designation means for designating a video range for outputting contents in first digital video contents related to a video image of the first digital contents, second digital contents forming means for integrating at least one video region on the basis of the designation of the output range designation means to form second digital video contents having a lower resolution, and contents output means for outputting the second digital contents.

The contents dividing device has a configuration in which, in the process of compressing the digital video contents into digital video contents having an amount smaller than that of original video data to transmit the digital video contents, a tiling process for dividing the video image into a plurality of video images and coding the video images is performed. The second digital contents forming means combines at least some of the tiles to perform reconstruction.

Furthermore, this system may employ a configuration in which a receiver can select a display range as described below.

More specifically, the digital broadcast receiving terminal includes display range designation means used when a receiver designates a desired display range in the display device, and display range notice means for noticing information of the display range to the delivery station. The second digital contents forming means receives information from the display range notice means to form second digital contents constituted by at least a part of an arbitrary range of the first digital contents.

In the second digital contents forming means, coding conversion which can convert a coding system depending on a digital broadcast receiving terminal of a delivery destination can also be performed. In this manner, a system which can cope with various coding systems can be provided.

The system may include interlocking audio conversion means for, when the second digital video contents constituted by at least a part of an arbitrary range of the first digital video contents are formed by the second digital contents forming means, converting the first digital audio contents related to sound into sound depending on the second digital video contents.

In this way, it is possible to deliver preferable digital contents in which audio data interlocks video data.

In the digital contents delivery system according to the present invention, the first digital contents include high-resolution digital video contents having a long side constituted by not less than 3000 pixels, and the digital broadcast receiving terminal is used in a television set in conformity with a television broadcasting system using a long side constituted by not more than 2000 pixels, the digital contents delivery system can cope with a conventional broadcasting system, is excellent in versatility, and is especially effective.

In this invention, there can be provided a method for accounting an information fee using the digital broadcast delivery system. In this case, the delivery station includes accounting information recording means to record an information fee on the accounting information recording means depending on digital contents to be delivered. The digital contents delivery system charges a user of the digital broadcast receiving terminal the information fee.

Only a contents editing device for editing digital contents can be provided.

This device includes contents input means for inputting first digital contents including high-resolution video information into the device, output range designation means for designating a video range for outputting contents in first digital video contents related to a video image of the first digital contents, second digital contents forming means for integrating at least one video region on the basis of the designation of the output range designation means to form second digital video contents having a lower resolution, and contents output means for outputting the second digital contents.

A digital broadcast receiving terminal for receiving digital contents delivered from the delivery station can also be provided.

The digital broadcast receiving terminal includes display means having a resolution lower than the resolution of the first digital video contents, display range designation means for designating a desired display range in the display means, display range notice means for noticing the display range to a delivery station side, and second digital contents receiving means for receiving second digital contents formed on the basis of the display range designated on the basis of the first digital contents.

The digital broadcast receiving terminal may be configured to receive first digital audio contents related to sound of the first digital contents, receive second digital video contents related to video data through the second digital contents receiving means, and convert and reproduce the first digital audio contents depending on the second digital video contents.

### BRIEF DESCRIPTION OF THE DRAWINGS

FIG. 1 is a diagram for explaining a conventional method of producing a television broadcast program.

FIG. 2 is a diagram for explaining conventional multi-channel simultaneous broadcasting of CS digital broadcasting.

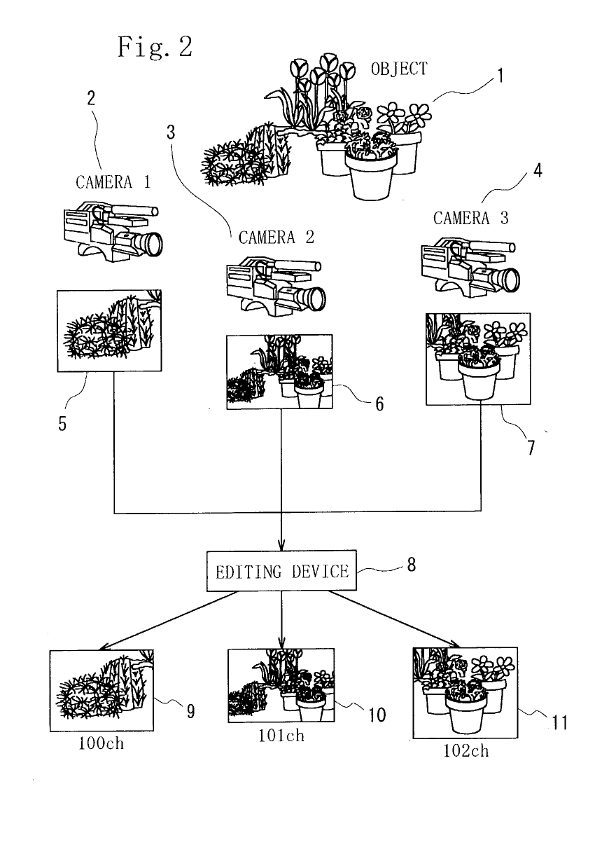

FIG. 3 is a diagram for explaining a contents producing method using a super-high definition camera according to the present invention.

FIG. 4 is a diagram of a configuration of a digital contents delivery system (part 1) according to the present invention.

FIG. 5 is a diagram of a configuration of a digital contents delivery system (part 2) according to the present invention.

FIG. 6 is a diagram showing a configuration of a contents receiving terminal according to the present invention.

FIG. 7 is a block diagram for explaining a digital contents editing device according to the present invention.

FIG. 8 is a diagram for explaining a code stream of JPEG2000.

FIG. 9 is a diagram showing video images obtained by photographing an athletic field by a video format having 3840 pixels in width and 1028 pixels in height.

FIG. 10 is a graph showing ratios of values of PSNR to compression rates in tile sizes.

Parts indicated by reference numerals as follows. 20: super-high definition video image, 20a: video range of lower left corner, 20b: video range of lower right corner, 21: digital contents editing device, 22: output video image 1, 23: output video image, and 24: output video image 3.

### DETAILED DESCRIPTION OF THE PREFERRED EMBODIMENT

An embodied method considered as the best method of the present invention will be described below with reference to an embodiment shown in the accompanying drawings.

Television broadcasting is exemplified as delivery of digital video contents. However, the embodiment of the present invention can be applied to not only the television broadcasting but also any delivery methods for video and audio data delivery using the internet for delivering digital contents.

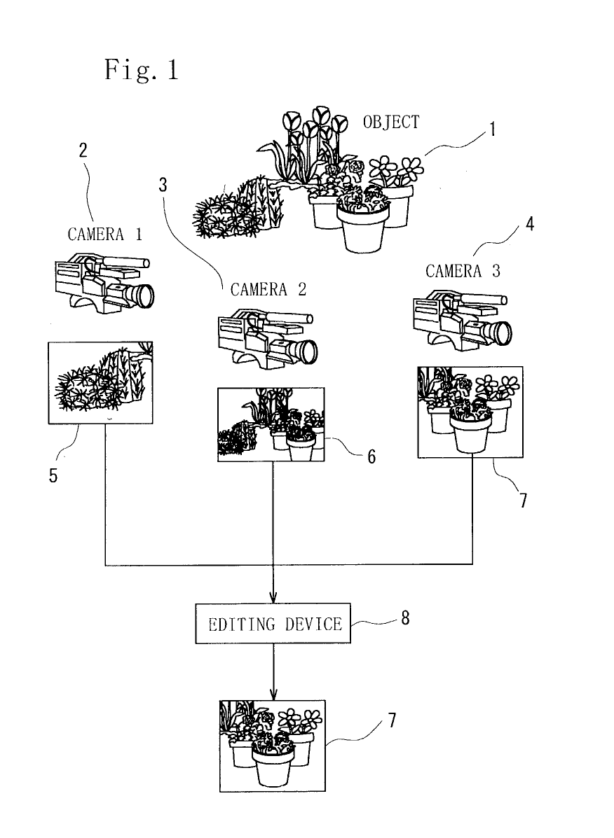

Alternatively, in the conventional method for producing a television broadcast program, a broadcast station selectively broadcasts video images of a plurality of cameras. For example, as shown in FIG. 1, three cameras (2), (3), and (4) are arranged for an object (1). The cameras (2), (3), and (4) photograph different video images (5), (6), and (7), and an editing device (8) selects, e.g., one arbitrary video image (7) to broadcast the video image.

In CS digital broadcasting, a system in which a plurality of camera video images are broadcasted to a plurality of broadcast channels and which causes an audience to select a channel is known. This method is as follows. That is, the video images (5), (6), and (7) of the cameras (2), (3), and (4) are broadcasted by 100 channels (9), (10), and (11), respectively.

However, in any cases, in a broadcast station, video images (5), (6), and (7) photographed by a camera operator are obtained by photographing a video range which is generally regarded to be optimum for many audiences by the camera operator. The method cannot accept detailed selection tastes of audiences.

In order to perform photographing by three cameras, photographing materials and photographing staffs for the three respective cameras are required to increase the cost.

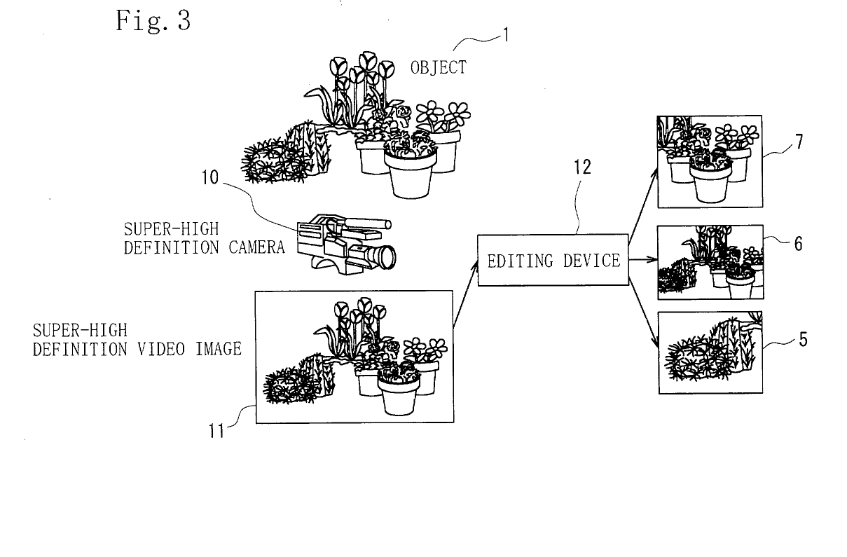

The present invention proposes the following broadcast delivery method. As shown in FIG. 3, by using a super-high definition camera (10) which can photograph a multi-pixel video image having pixels the number of which is larger than that of a conventional TV format of the NTSC system or the HDTV system, the object (1) is entirely photographed to obtain a super-high definition video image (11). A video image portion in conformity with the NTSC system or the HDTV system is selected from an arbitrary position of the video image to output the video images (5), (6), and (7).

For example, the present inventors provide a video format having 3840 pixels in width and 1028 pixels in height in a high definition video transmission system described in Reference 1. This system can obtain a super-high definition video image corresponding to two screens in the lateral direction of a normal HDTV video format.

[Reference 1]

Kenji Tanaka, Kenji Suzuki, Masato Sato, Yoshiki Arakawa, “High definition video image (WHD: Wide/Double HD) transmission system”, Denshi Joho Tsushin Gakkai Ronbunshi, D-II, Vol. J84-DII, No. 6, pp. 1094-1101, June. 2001.

This high definition video transmission system is further advanced to develop a QHD (Quadruple HD, 3840 pixels in width and 2048 pixels in height) serving as a video format which is twice the format of the HDTV system both in width and in height. A camera (Reference 2) and a display projector (Reference 3) of the QHD are also realized.

[Reference 2]

Eiji Tanaka, Kenji Tanaka, Kenji Suzuki, Mitsuo Isogai, Yoshiki Arakawa, Masato Sato, “Development of Three-plate Type 4k*2k CMOS Color Camera”, General Conference of The Institute of Electronics Information and Communication Engineers, D-II-69, March 2001.

[Reference 3]

Tanaka Kenji, Isogai Mitsuo, Arakawa Yoshiki, Sato Masato, “Projector for Q-HDTV”, Annual Meeting of The Institute of Information and Television Engineers, 10-7, August 2001.

As described above, a photographing device having a resolution which is considerably higher than the resolution of the HDTV system has been realized. It is expected that the photographing device is further advanced. On the other hand, on the receiver side, television sets of the HDTV system are being popularized. Direct reproduction of the contents obtained by the latest photographing devices is not yet in sight.

The resolution of a photographing device which will be introduced by a broadcasting company in the future is always expected to be higher than that of the equipment on the receiver side. The delivery side is requested to cope with various receivers. The receiver side is requested to achieve an advantage of excellent equipment on the delivery side.

Therefore, when the present invention is used, digital video contents (11) having, e.g., 3840×2048 pixels and photographed by the super-higher definition camera (10) are input to the editing device (12), and the video images (5), (6), and (7) are output by the editing device (12). The video images can be output with an arbitrary broadcast format of the NTSC system, the HDTV system, or the like. The details of this method will be described below.

According to the above method, since necessary video information can be photographed without camera operations such as zooming, tilting, and panning, efficiency such as a reduction in number of cameras and a reduction in number of camera operators can be achieved.

In this embodiment, audio balance adjustment can also be performed depending on the position of a selected video portion. For example, in photographing of the super-high definition video image (11), sound is recorded on the basis of a range in the video image (11). In reproduction of the video images (5), (6), and (7), sound near a range projected by the video images is loud, and sound of a range distant from the projected range is attenuated or vanished.

Accordingly, sound depending on a video image can be reproduced, and areal video image can be heard and watched without any sense of discomfort.

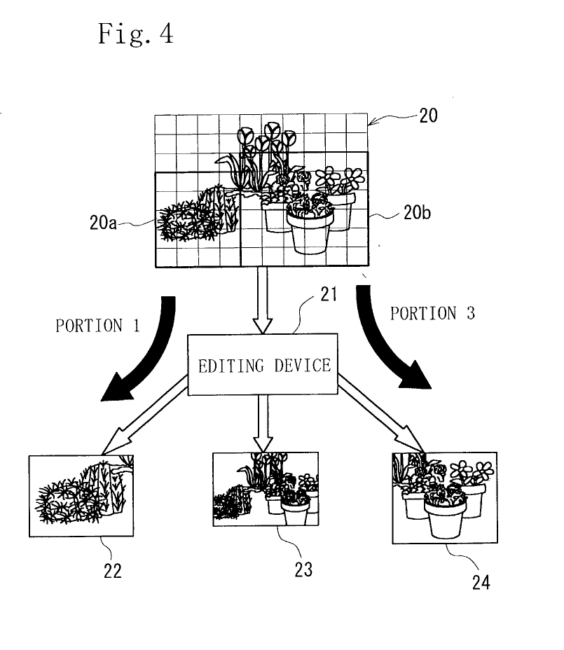

FIG. 4 shows an outline of a digital contents editing device (21) for dividing a super-high definition video image (20) into a plurality of blocks and delivering a plurality of video images of a conventional television broadcasting system such as the NTSC system or the HDTV system.

An entire object is photographed to obtain the super-high definition video image (20). The super-high definition video image (20) is input to the device (21), a video range in conformity with the NTSC system or the HDTV system is selected from an arbitrary position of the video image (20), and video images (22), (23), and (24) are output. These video images are simultaneously broadcasted, and an audience selects an arbitrary channel.

At this time, the super-high definition video image (20) is selected into 10×8 blocks arranged in width and height. A lower left video range (20a) is projected on the video image (22), an entire video range (20) is projected on the video image (23), and a video range (20b) at the lower right is projected on the video image (24).

All the video images may be broadcasted by the same broadcasting system, and for example, the video images (22) and (24) may be broadcasted by the NTSC system, and the video image (23) may be broadcasted by the HDTV system different from the NTSC system.

Different photographing devices and different editing devices are required for the conventional broadcasting systems, respectively. However, since the method of the present invention can be realized, suppression of the cost and improvement of contents quality can be expected.

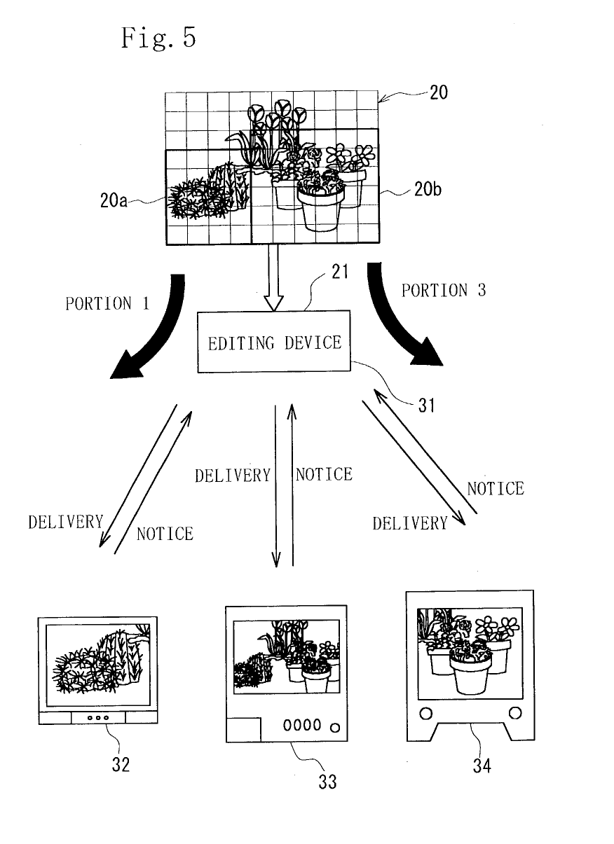

In addition, according to the present invention, a configuration in which a video range to be delivered depending on a request from an audience can also be provided. The configuration of the digital contents delivery system is shown in FIG. 5.

When a super-high precision video image (20) photographed by a super-high definition camera (30) is transmitted, a coding process is performed such that the super-high definition video image (20) is divided into small parts. In this case, a digital contents editing device (31) selects one of the parts depending on a request from an audience to provide the part.

The audience designates her/his desired video range from the receiving terminals (32), (33), and (34) such as television sets, and demands the video range from the digital contents editing device (31).

For example, only data corresponding to the video range (20a) in coded data is provided to an audience who desires a video image at a lower left corner such as the video image (22). When an entire image such as the video image (23) is desired, entire coded data (20) to the audience. Data corresponding to the video range (20b) in the coded data is provided to an audience who desires the image at the lower right corner such as the video image (24). Balance adjustment of sound depending on a selected portion is performed.

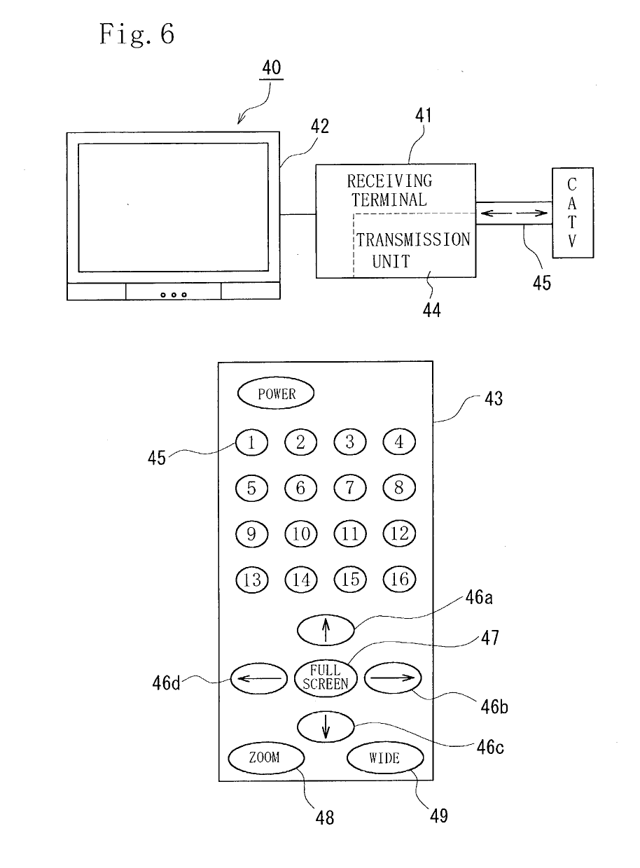

A configuration of a contents receiving terminal according to the present invention is shown in FIG. 6. The receiving terminal (40) comprises a receiving terminal unit (41) for receiving broadcast from, e.g., a cable television company, a display unit (42), an operation unit (43) of the display device, and a transmission unit (44) for transmitting designation information of a video range. The transmission unit (44) is attached to the receiving terminal unit (41).

An audience selects a broadcast station by a channel button (45) to display desired contents. The display range is moved by display range designation buttons (46a), (46b), (46c), and (46d). For example, when the audience wants to watch the right side of the present display range, the audience depresses the button (46b) to make it possible to move the display range to the right.

When the audience wants to overlook the full screen, the audience depresses a full screen button (47). When the audience wants to extend and contract the display range, the audience depresses a zoom button (48) and a wide button (49). In this manner, the audience can realize a video image display suitable for her/his taste.

At this time, depression information of the buttons (46a to 46d), (47), (48), and (49) is noticed as video range designation information from the transmission unit (44) to the digital contents editing device (21) through a cable television line (45).

In the digital contents delivery device (21), the following coding process is performed to deliver digital contents depending on the video range designation information.

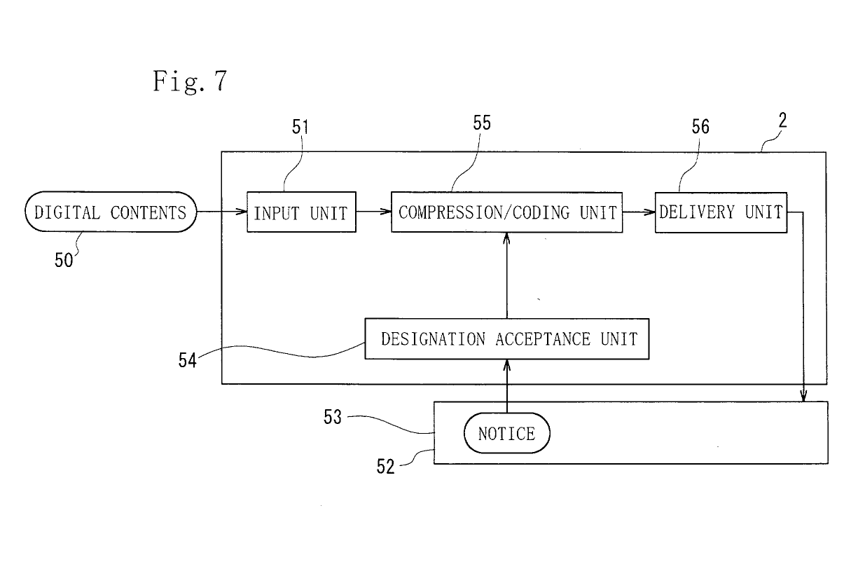

A configuration of the digital contents editing device (21) is shown in FIG. 7. In the present invention, as an example, digital contents (50) using the JPEG2000 system which has been standardized in recent years are input from an input unit (51). Video range designation information (53) from a contents receiving terminal (52) is received by a designation acceptance unit (54). Reconstruction of the digital contents (50) is performed by a compression/coding unit (55), and the digital contents are delivered from a delivery unit (56).

In the JPEG2000 system, wavelet conversion, block base entropy coding, and arithmetic coding are performed, and image quality rarely visually deteriorated at a compression rate of about 1/10. In addition, the JPEG2000 system has a characteristic feature in which visual deterioration is less than that of a coding system such as a conventional JPEG system using DCT conversion even at a high compression rate.

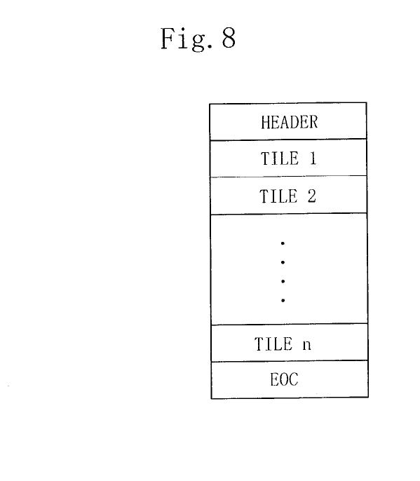

A tiling function which divides one video image into a plurality of blocks to perform a decoding process can be selected. A code stream obtained when a video image is divided into n blocks is shown in FIG. 8.

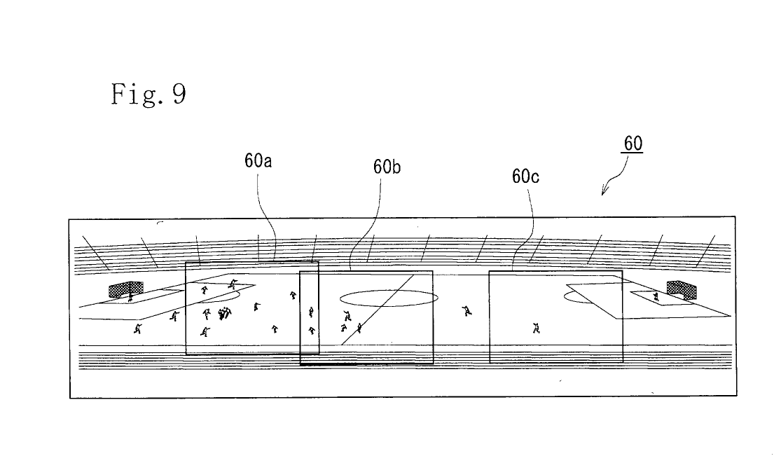

There will be considered a case in which, in the video format having 3840 pixels in width and 1028 pixels in height, the method is applied to a soccer stadium. A video image (60) which can vividly photograph the area in the field, the benches of both teams, and seats can be obtained from a static angle as shown in FIG. 9.

When three audiences want to watch video ranges corresponding to the size of the NTSC system shown by three video ranges (60a), (60b), and (60c) in FIG. 9, the digital contents (50) is coded in advance by using the tiling function of JPEG2000.

In the compression/coding unit (55), a code stream is restructured by using tiling information of necessary portions required by the audiences. The code stream is delivered from the delivery unit (56).

At this time, selection of a tile size and a compression rate is important. The present invention proposes the followings. That is, a PSNR relation obtained when data having 3840 pixels in width and 2048 pixels in height and having a capacity of 23 Mbytes is tiled and compressed is examined, a tiling size is approximately set to be 64 pixels×64 pixels (tiling number: 1920) to 960 pixels×512 pixels (tiling number: 16), and a compression rate is set to be lower than 1/10.

In the compression/coding unit (55), the coding system of the digital contents (50) can also be converted into an arbitrary coding system.

For example, when the digital contents (50) are coded by JPEG2000, according to the notice (53) from the contents receiving terminal (52), the digital contents can also be converted into digital contents of another system such as MPEG2, JPEG, or MPEG4 and delivered.

For example, when digital contents to be input use a unique system, the digital contents may be uniformly converted into digital contents of another system regardless of the notification (53).

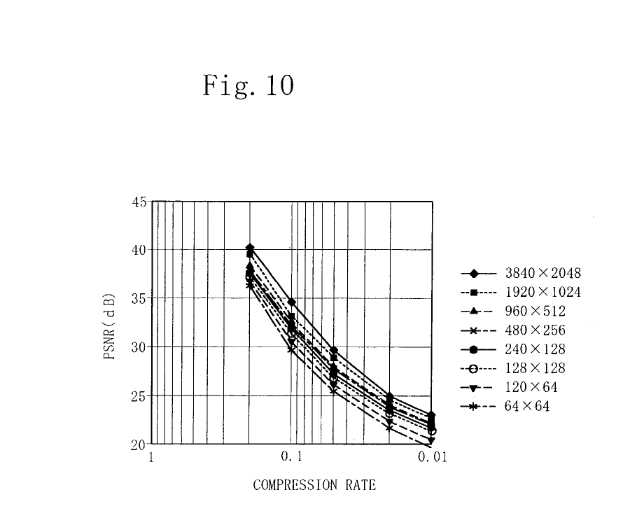

As is apparent from a relation between a compression rate and a PSNR obtained when the tile size of the video image shown in FIG. 10, when the number of divided tiles increases, overhead data of each tile increases, and the PSNR decreases. For this reason, it is not appropriate that the tile cannot be unnecessarily divided into small tiles.

On the contrary, when a tile size is large, a larger amount of data of a portion which is not required by an audience are transmitted, the delay of delivery and a lack of the data may occur.

Therefore, the above range which obtains an almost preferable result and in which high estimation can be achieved even in a video test independently performed by a test subject is employed as an optimum range.

The test is based on the standards of JPEG2000 which is considered to be optimum at the present. With an improvement in compression/tiling process technique in the future, more segmentised tiling and an increase in compression rate may be achieved. The present invention is not limited to the above range.

For example, on the basis of the standards of JPEG2000, although the tiling process is used, the present invention can be used in delivery of digital contents formed by the standards such as JPEG, MPEG1, and MPEG2 which are conventionally used.

More specifically, one set of digital video contents formed by these standards are divided into a plurality of blocks in respective regions. These blocks are subjected to a compression process are simultaneously delivered, and a block to be reproduced of the blocks can be reproduced in the receiving terminal.

As a matter of course, a block to be delivered may be selected depending on the characteristics of a receiving terminal on the delivery side. According to these methods, the advantage of the present invention can be obtained. That is, one set of contents can cope with a plurality of receiving terminals while suppressing an amount of data to be delivered.

The above embodiment exemplified the case in which digital contents having definition higher than that of the conventional NTSC system and the conventional HDTV system are used. However, in the embodiment of the present invention, arbitrary first digital contents and arbitrary second digital contents can be used.

For example, contents photographed by the HDTV system are used as the first digital contents and can also be delivered to a mobile terminal. Although mobile terminals slightly comprise display devices having high resolutions to achieve reductions in size, since the types of the mobile terminals are various, the digital contents cannot cope with all the mobile terminals.

The present invention can easily cope with a plurality of resolutions. In particular, it is considered that the present invention cal be cope with almost all mobile terminals by using digital contents having a relatively large margin such as digital contents of the HDTV system as the first digital contents.

In this case, a function which converts a system for compressing the first digital contents into a system the contents of which can be reproduced by the mobile terminals may be arranged.

There can also be provided a system for collecting information fees by using the digital broadcast delivery system. More specifically, in recent years, information fees are frequently charged in the name of viewing and listening fees when movies or useful information are delivered as digital contents. In this system, it is possible to charge information fees.

In this case, accounting information of each digital broadcast receiving terminal is recorded on a delivery station, and an audience is charged every delivery or every predetermined period such as one month. The fee can be collected from a registered bank account registered in advance by the audience by automatic deduction service.

Therefore, the account information is recorded on accounting information recording means included in the delivery station. However, in this case, the accounting information may also be recorded on the basis of the number of blocks (tiling number), an amount of data which is actually delivered, the number of frames of a video image, and reference time.

In this manner, in the accounting method in the digital broadcast delivery system according to the present invention, since an amount of money to be charged can also be changed depending on an amount of transmitted information or reference time, the following differentiation can be achieved. That is, a large amount of money is charged when data is delivered with a high resolution, and a small amount of money is charged when a small amount of data received by a mobile terminal or the like.

In this configuration, accounting can be performed by using a delivery request from the terminal side as a trigger. In contrast to this, data can also be scrambled in compression on the delivery side, and accounting can be performed with transmission of a cancel signal of the scramble.

Delivery is not performed without a delivery request from the terminal side, or the data is scrambled to make it possible to prevent an illegal use of the system.

The present invention has the above configuration, the following advantages are achieved. More specifically, according to the digital contents delivery method of the present invention, unlike a conventional method, delivery contents for the NTSC system and delivery contents for the HDTV system are formed on the basis of an image photographed by one HDTV camera, and contents of a plurality of video ranges can be formed on the basis of a video image photographed by an HDTV camera in at least the NTSC system without deteriorating image quality. In addition, when a high-resolution camera is used, a plurality of video ranges can be produced even in delivery of the HDTV system.

Digital contents are compressed and coded to perform a tiling process, so that an amount of data to be delivered can be suppressed. The present invention can cope with a large number of requests in designation of a video range from the receiver side.

Furthermore, according to the present invention, balance adjustment of sound is performed in accordance with video information, a video image and sound which are viewed and heard are interlocked with each other, effective digital contents with concert-hall presence can be delivered without sense of discomfort.

As described above, the digital contents delivery method according to the present invention realizes a method which can achieve labor-saving and which can cope with an increase in number of channels and diversification of broadcasting systems at low cost.

At the same time, a video range can be freely selected by at least one of a deliverer and a receiver. A plurality of photographing devices and a plurality of staffs are not required on the deliverer side, and the receiver can enjoy contents suitable for her/his taste.

What is claimed is:

1. A digital broadcast delivery method for transmitting digital contents from a transmission side to a reception side, wherein
the digital contents are divided into predetermined blocks, and combinations of the blocks are freely changed to reproduce an arbitrary range of at least a part of the digital contents.

2. The digital broadcast delivery method according to claim 1, wherein
in the process of compressing the digital video contents related to a video image of the digital contents into digital contents the amount of which is smaller than that of original data of the video image, a tiling process for dividing the video image into a plurality of video images and coding the video images is performed, and
on at least one of the transmission side and the reception side, at least some of the tiles are combined to be reconstructed, so that an appropriate display range can be displayed on the reception side.

3. The digital broadcast delivery method according to claim 1, wherein
at least two ranges of
digital contents in a first range constituted by at least a part of the range of the digital contents and
digital contents in a second range constituted by a range different from the range of the digital contents in the first range are simultaneously delivered on the transmission side, and
a desired range is selected to perform reproduction on the reception side.

4. The digital broadcast delivery method according to claim 2, wherein
at least two ranges of
digital contents in a first range constituted by at least a part of the range of the digital contents and
digital contents in a second range constituted by a range different from the range of the digital contents in the first range are simultaneously delivered on the transmission side, and
a desired range is selected to perform reproduction on the reception side.

5. The digital broadcast delivery method according to claim 1, wherein
in a configuration in which, of the digital contents, digital video contents including digital audio contents related to sound are used to display at least a part of a display range of the digital video contents,
the digital audio contents are converted into sound depending on the display range and reproduced.

6. The digital broadcast delivery method according to claim 2, wherein
in a configuration in which, of the digital contents, digital video contents including digital audio contents related to sound are used to display at least a part of a display range of the digital video contents,
the digital audio contents are converted into sound depending on the display range and reproduced.

7. The digital broadcast delivery method according to claim 3, wherein
in a configuration in which, of the digital contents, digital video contents including digital audio contents related to sound are used to display at least a part of a display range of the digital video contents,
the digital audio contents are converted into sound depending on the display range and reproduced.

8. The digital broadcast delivery method according to claim 4, wherein
in a configuration in which, of the digital contents, digital video contents including digital audio contents related to sound are used to display at least a part of a display range of the digital video contents,
the digital audio contents are converted into sound depending on the display range and reproduced.

9. A digital broadcast delivery system for delivering digital contents from a delivery station to a digital broadcast receiving terminal, the delivery station comprising a contents forming device, a contents dividing device, a contents editing device, and a delivery device, and the digital broadcast receiving terminal comprising a receiving device and a display device, wherein
the contents dividing device divides, of digital contents including video information having a high resolution and formed by the contents forming device, digital video contents related to a video image into video regions of a fixed size serving as blocks to form first digital contents, and
the contents editing device includes:
contents input means for inputting the first digital contents into the device;
output range designation means for designating a video range for outputting contents in first digital video contents related to a video image of the first digital contents;
second digital contents forming means for integrating at least one video region on the basis of the designation of the output range designation means to form second digital video contents having a lower resolution; and
contents output means for outputting the second digital contents.

10. A digital broadcast delivery system according to claim 9, wherein
the contents dividing device has a configuration in which, in the process of compressing the digital video contents into digital video contents having an amount smaller than that of original video data to transmit the digital video contents, a tiling process for dividing the video image into a plurality of video images and coding the video images is performed, and
the second digital contents forming means combines at least some of the tiles to perform reconstruction.

11. The digital broadcast delivery system according to claim 9, wherein
the digital broadcast receiving terminal comprises display range designation means used when a receiver designates a desired display range in the display device, and display range notice means for noticing information of the display range to the delivery station, and
the second digital contents forming means receives information from the display range notice means to form second digital contents constituted by at least a part of an arbitrary range of the first digital contents.

12. The digital broadcast delivery system according to claim 10, wherein
the digital broadcast receiving terminal comprises display range designation means used when a receiver designates a desired display range in the display device, and display range notice means for noticing information of the display range to the delivery station, and
the second digital contents forming means receives information from the display range notice means to form second digital contents constituted by at least a part of an arbitrary range of the first digital contents.

13. The digital broadcast delivery system according to claim 9, wherein
the second digital contents forming means performs coding conversion which can convert a coding system in accordance with the digital broadcast receiving terminal to which the contents are delivered.

14. The digital broadcast delivery system according to claim 10, wherein
the second digital contents forming means performs coding conversion which can convert a coding system in accordance with the digital broadcast receiving terminal to which the contents are delivered.

15. The digital broadcast delivery system according to claim 11, wherein
the second digital contents forming means performs coding conversion which can convert a coding system in accordance with the digital broadcast receiving terminal to which the contents are delivered.

16. The digital broadcast delivery system according to claim 12, wherein
the second digital contents forming means performs coding conversion which can convert a coding system in accordance with the digital broadcast receiving terminal to which the contents are delivered.

17. The digital broadcast delivery system according to claim 9, comprising
interlocking audio conversion means for, when the second digital video contents constituted by at least a part of an arbitrary range of the first digital video contents are formed by the second digital contents forming means, converting the first digital audio contents related to sound into sound depending on the second digital video contents.

18. The digital broadcast delivery system according to claim 9, wherein
in the first digital contents including high-resolution digital video contents having a long side constituted by not less than 3000 pixels,
the digital broadcast receiving terminal is a television set in conformity with a television broadcasting system using a long side constituted by not more than 2000 pixels.

19. A method for accounting an information fee using the digital broadcast delivery system according to claims 5 to 9, wherein
the delivery station comprises accounting information recording means,
an information fee is recorded on the accounting information recording means depending on digital contents to be delivered, and
the information fee is charged to a user of the digital broadcast receiving terminal.

20. A digital contents editing device for editing digital contents, comprising:
contents input means for inputting first digital contents including high-resolution video information into the device;
output range designation means for designating a video range for outputting contents in first digital video contents related to a video image of the first digital contents;
second digital contents forming means for integrating at least one video region on the basis of the designation of the output range designation means to form second digital video contents having a lower resolution; and
contents output means for outputting the second digital contents.

21. A digital contents editing device according to claim 20, wherein
in a configuration in which the first digital video contents are data which are compressed into digital video contents having an amount smaller than that of original video data and which are subjected to a tiling process for dividing the video image into a plurality of video images to code the video images,
the second digital contents forming means reconstructs at least some of the tiles.

22. The digital contents editing device according to claim 20, wherein
the second digital contents forming means performs coding conversion which can convert a coding system depending on the digital broadcast receiving terminal to which the contents are delivered.

23. The digital contents editing device according to claim 21, wherein
the second digital contents forming means performs coding conversion which can convert a coding system depending on the digital broadcast receiving terminal to which the contents are delivered.

24. The digital contents editing device according to claim 20, wherein
the second digital contents forming means converts first digital audio contents related to sound of the first digital contents into second digital audio contents depending on the second digital video contents.

25. A digital broadcast receiving terminal which receives digital contents delivered from a delivery station, wherein
in a configuration, first digital video contents related to a video image of first digital contents including video information having a high resolution are divided into video regions of a fixed size and delivered,
the digital broadcast receiving terminal comprises:
display means having a resolution lower than the resolution of the first digital video contents;
display range designation means for designating a desired display range in the display means;
a display range notice means for noticing the display range to a delivery station side; and
second digital contents receiving means for receiving second digital contents which are formed on the basis of the display range designated on the basis of the first digital contents.

26. The digital broadcast receiving terminal according to claim 25, wherein
the digital broadcast receiving terminal
receives the first digital contents related to sound of the first digital contents,
receives second digital video contents related to a video image through the second digital contents receiving means, and
converts the first digital audio contents depending on the second digital video contents and reproduces the first digital audio contents.
